(19) United States
(12) Patent Application Publication
(10) Pub. No.: US 2003/0015057 A1
(43) Pub. Date: Jan. 23, 2003

(54) Extensible jack handle

(75) Inventors: Brian J. Berdan, Montgomery, MN (US); James E. Jirele, Owatonna, MN (US); Brian C. Peterson, Faribault, MN (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 09/911,288

(22) Filed: Jul. 23, 2001

(51) Int. Cl. G05G 1/00

(52) U.S. Cl. 74/544

(57) ABSTRACT

An extensible handle includes an elongated inner member and an elongated outer member. The outer member is hollow and telescopically receives the inner member. The inner member includes a section having an expanded width, and the outer member includes a restriction so that when the section having expanded width contacts the restriction, the inner member is prevented from fully passing through the outer member. The extendability of the handle allows the handle to be used with vehicle part jacks and other applications where handles of varying lengths are desired.

### FIELD OF THE INVENTION

The present invention relates generally to jack handles. More particularly, the present invention relates to handles for low profile lifting devices, such as devices for lifting vehicle transmissions, clutches, or other parts, wherein the device has a handle that may be adjusted to varying lengths.

### BACKGROUND OF THE INVENTION

Many motor vehicles are designed so that certain parts, such as transmissions and clutches, are removed and/or installed from the underside of the vehicle. This design facilities installation and removal of the parts because such parts are often very heavy, and thus they can be more easily raised and lowered from the underside than from above the vehicle. Such parts are typically raised into place and/or lowered from the vehicle with a jack that provides support for the part.

Most vehicle jacks have handles of finite lengths. However, a handle of finite length often is not desirable in varying working conditions. For example, if the handle is too short, when the jack is under the vehicle the user will be limited in its ability to place the jack in locations under the vehicle that are out of reach. In addition, a short handle requires more force to raise and/or lower the jack. Conversely, if the handle is too long, activation of the jack may be interfered with by other parts of the vehicle, such as tires or other parts. In addition, a wide clearance space around the vehicle is required to install a jack having a long handle.

Prior art jacking devices have attempted to solve this problem by providing jack handles of varying lengths. However, the means by which handles of varying length have been provided have been limited to providing multiple length handles, and the user has thus been required to remove and install a new handle whenever a handle of different length is desired. In addition, multi-part handles have been provided, but such handles also require the user to add additional parts as additional length is desired. For example, a handle made in two sections which are temporarily connected together to operate the jack and then separate it into two pieces for storage is disclosed in U.S. Pat. No. 2,671,636.

It is therefore desirable to provide an extensible handle for use with jacks, dollies, and other items such that the user to extend and retract the handle without removal or addition of parts to the handle.

### SUMMARY OF THE INVENTION

It is therefore a feature and advantage of the present invention to provide an improved handle that may be extended and retracted to multiple positions without requiring the installation of removal of handle parts.

The above and other features and advantages are achieved through the use of a novel extendible jack handle as herein disclosed. In accordance with one embodiment of the present invention, an extensible handle includes a first elongated member having two ends, the first of which is positioned to engage a device to be operated. The first elongated member also has an expanded portion, which has an increased width, and a narrow portion, which has a width that is narrower than that of the expanded portion, The handle also includes a hollow second elongated member that has two ends and a restricting means. The second elongated member is positioned to receive, into one or both of its ends, the first elongated member.

Optionally, the restricting means has a width that is narrower than the width of the expanded portion of the first elongated member. Optionally and preferably, the restricting means restricts the expanded portion of the first elongated member from fully passing through both ends of the second elongated member.

As additional options, the first elongated member and/or the second elongated member may be comprised of steel, iron, aluminum, another metal, a composite material such as a carbon fiber composite material, and/or a resilient plastic, optionally including a reinforced plastic such as a fiberglass reinforced plastic. The first elongated member may also include at least one locking means, such as a receptacle, groove, or notch sized and positioned to securely receive an item such as a pin. The second elongated member may also include a locking means positioned to receive the pin and prevent extension and/or retraction of the handle. In accordance with an optional and preferred embodiment, activation of the handle by a user activates a jacking device or dolly.

In accordance with an additional embodiment of the present invention, an apparatus for moving an item includes a base, a supporting means positioned above the base, and an arm having two ends. The arm is positioned so that one end is pivotally related to the supporting member and the other end is pivotally related to the base. The apparatus also includes a lifting means and a handle. The handle includes a first elongated member having two ends, the first end positioned to be received by the apparatus. The second end has an expanded portion of an increased width relative to another portion of the first elongated member. The handle also includes a second elongated member having two ends. The second elongated member is hollow and is positioned to receive the first elongated member into one of the ends. The second elongated member also includes a restricting means having a width that is narrower than the width of the expanded portion of the first elongated member.

Optionally and preferably, the restricting means restricts the expanded portion of the first elongated member from fully passing through the second elongated member. Further, activation of the handle by a user preferably activates the lifting means, which in turn activates the arm and vertically moves the supporting means.

As additional options, at least one of the first and the second elongated member may be comprised of steel, iron, aluminum, another metal, a composite material and/or a resilient plastic, optionally including a reinforced plastic. Also, the first elongated member may include at least one locking means, such as a receptacle, groove, or notch sized and positioned to securely receive an item such as a pin. The second elongated may also include a locking means positioned to receive the pin and prevent extension and/or retraction of the handle.

In accordance with yet another embodiment of the present invention, an extensible handle includes a first elongated member having two ends, an expanded portion of increased width, and a narrow portion of reduced width relative to that of the expanded portion. The handle also includes a hollow second elongated member having two ends. The second elongated member is positioned to telescopically receive the first elongated member. The second member also includes a means for restricting the expanded portion of the first elongated member from fully passing through both ends of the second elongated member.

Optionally, the first elongated member also includes a means for restricting movement of the first elongated member on an axis relative to the second elongated member. Optionally and preferably, the handle further includes a means for preventing extension and/or retraction of the handle. Also optionally and preferably, the first elongated member further includes a means for securing the first elongated member to a device to be operated, and the first elongated member and/or the second elongated member may be comprised of metal.

There have thus been outlined the more important features of the invention in order that the detailed description thereof that follows may be better understood, and in order that the present contribution to the art may be better appreciated. There are, of course, additional features of the invention that will be described below and which will form at least part of the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting in any way.

As such, those skilled in the art will appreciate that the concept and objectives, upon which this disclosure is based, may be readily utilized as a basis for the design of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 provides a side view of a jack having a preferred embodiment of an extensible handle.

FIG. 2 provides a perspective view illustrating several elements of a first member of a preferred embodiment of an extensible handle.

FIG. 3 provides a perspective view illustrating several elements of a second member of a preferred embodiment of an extensible handle.

FIG. 4 provides a perspective view of a collar that may be used with a preferred embodiment of the present inventive handle.

### DETAILED DESCRIPTION OF PREFERRED EMBODIMENTS OF THE INVENTION

A preferred embodiment of the present invention provides an improved extensible handle that allows the handle to be used in multiple positions corresponding to multiple lengths. The handle may be used with any type of item, and it is preferably used with a jack or dolly for the movement of vehicle parts. The handle is particularly useful for vehicle jacks such as those used to raise or lower a clutch or transmission underneath a vehicle.

The handle may be extended to provide for increased length so that the jack can be moved into positions requiring a long reach. The increased length also allows for operation of the jack with lower force than would be required for a shorter handle. Increased length is also desirable in applications where the handle is used as a tow bar, such as with a dolly. The handle also may be retracted into a shorter position to allow for improved maneuverability of the jack in confined or obstructed areas. Preferably, the handle may be extended or retracted without removal of the handle from the jack or dolly and without addition or removal of parts to the handle.

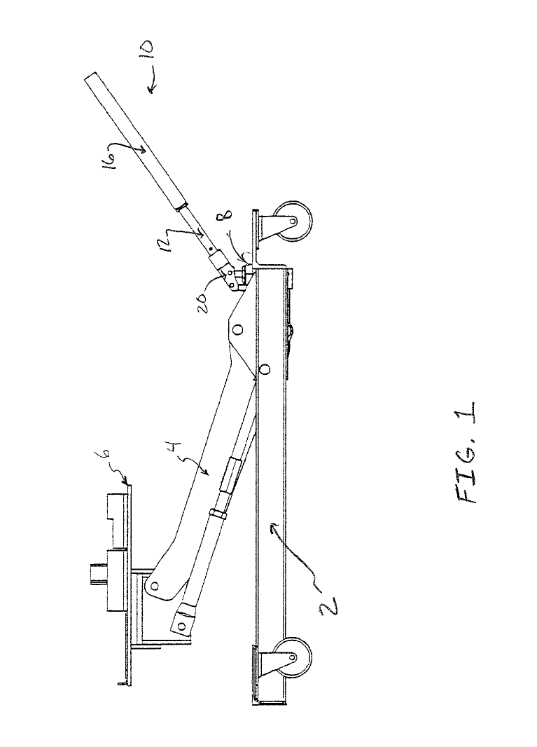

FIG. 1 illustrates an example of a jack that is equipped with a preferred embodiment of the present inventive extensible handle. The jack includes a base 2. The jack also includes a support means 6 or other piece, such as a platform, handle, hook, latch, screw, or other item, on which an item to be raised and/or lowered by the jack may rest. An arm 4 is pivotally connected both to the platform 6 and the base 2. The jack is also equipped with an extensible handle 10 comprised of an inner member 12 and a hollow outer member 16.

A lifting mechanism 8 such as a hydraulic cylinder, pump, spring, or other device is also provided so that when the lifting mechanism 8 is operated, the arm 4 is raised or lowered, thus raising or lowering the support member 6. For example, the lifting mechanism 8 may be a hydraulic cylinder positioned horizontally under the handle 10 and along the base 2. In such an embodiment, the cylinder is preferably equipped with a ram that extends when the cylinder is operated. When the ram extends from the cylinder, it pulls the arm 4, which vertically raises the support member 6. Of course, other configurations and embodiments of lifting mechanism 8 may be used, such as cylinders in other positions, springs, latches, and other devices, all of which may be used with the present inventive handle. The handle 10 is received by the jack at a connector 20 such as a screw receptacle, pin receptacle, latch, or other mechanism positioned so that when handle 10 is operated, the lifting means 8 is also operated, thus raising or lowering the arm 4 and support member 6 as appropriate.

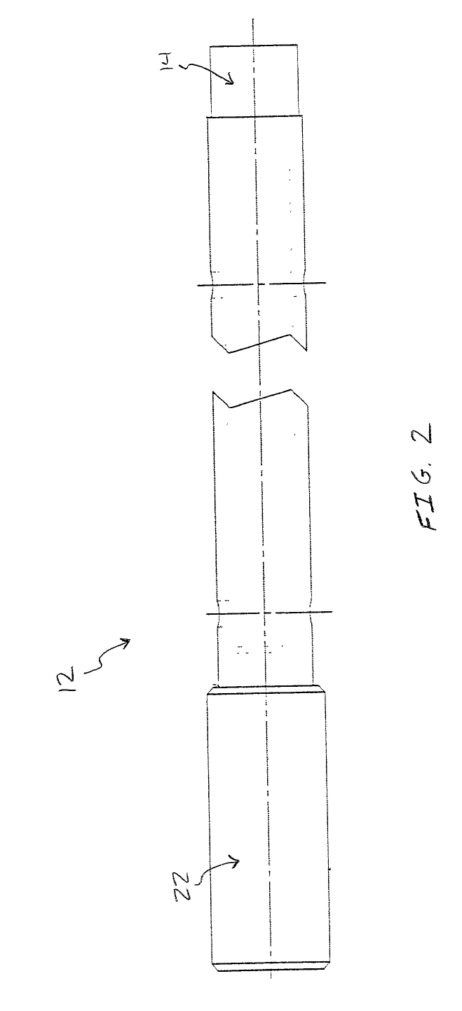

FIG. 2 provides an expanded view of the inner member 12 of the handle. Referring to FIG. 2, the inner member includes a first end 14 that is designed to be received by the jack's connecting mechanism 20. First end 14 may be threaded or it may be equipped with other features, such as one or more notches, grooves, hooks, extensions, or other items to engage the receptacle 20. The other end of first member 12 includes an expanded portion 22 having a width or diameter that is larger than the width or diameter of the remainder of inner member 12. End 14 may also have a width that is optionally less than, greater than, or equal to that of the remainder of the support member, which width may even optionally be less than, greater than, or equal to that of the expanded portion 22.

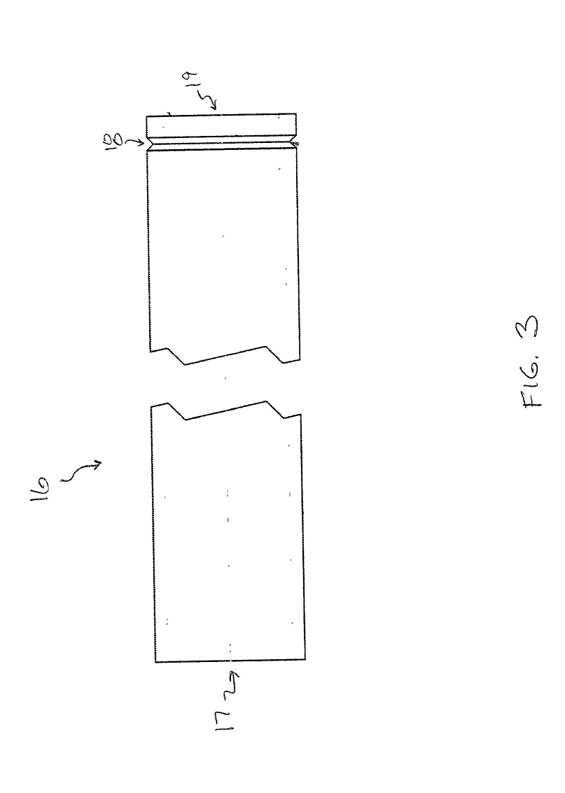

An expanded view of the outer member 16 is illustrated in FIG. 3. Referring to FIG. 3, the outer member 16 includes a first opening 17 and a second opening 19. A restriction 18 is provided in order to provide an inner diameter that is smaller than the inner diameter of other portions of the member. Preferably, the restriction 18 is near second opening 19 as illustrated in FIG. 3, although restriction 18 may in fact be located anywhere along the outer member 16.

The extendible handle is assembled by placing the first end 14 of the inner member 12 in to the outer member 16 by passing the first end 14 through opening 17 until the expanded portion 22 of the inner member contacts the restriction 18.

Restriction 18 prevents inner member 12 from being passed entirely through outer member 16 but allows for movement of inner member 12 along its length until extended portion 22 contacts the restriction 18. Inner member 12 and outer member 16 are thus telescopically related to each other. The handle is then attached to the jack by attaching the first end 14 of inner member 12 to receptacle 20.

The embodiments of the inner member and outer member illustrated in FIGS. 2 and 3 are merely intended to be illustrative, and other embodiments may be used. For example, inner member 12 and outer member 16 may be of any length. Further, the relative lengths of the expanded portion 22, the first end 14, and the remaining portion of inner member 12 may be longer or shorter than that illustrated in FIG. 2, depending on the desired application. In addition, although FIG. 3 illustrates restriction 18 as a groove around the entire circumference of outer member 16, any restriction, such as one or more pins and/or raised portions placed inside of outer member 16 may be used. Preferably, as illustrated in FIG. 2, restriction 18 is located near one of the ends of outer member 16, although optionally restriction 18 may be located at any location along outer member 16. In addition, although the shapes of inner member 12 and outer member 16 are shown to be cylindrical, other shapes such as square, rectangular, triangular, or any other shapes may be used to form the inner member 12 and outer member 16. Further, although outer member 16 must be hollow, inner member 12 may be either solid or hollow.

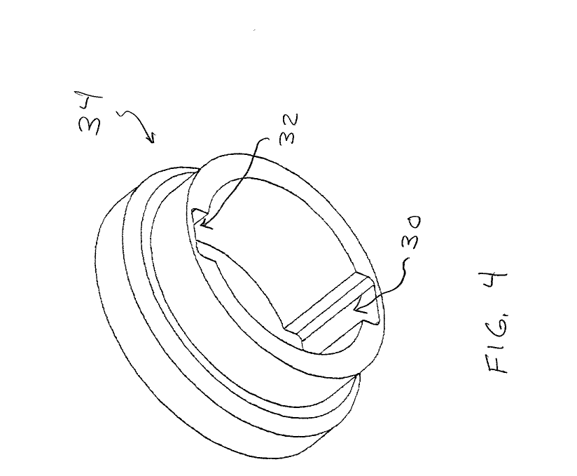

FIG. 2 illustrates that inner member 12 is also preferably equipped with one or more receptacles 24 and 26 or other locking means so that restricting devices can be attached to the inner member in order to lock the inner member into one or more positions. For example, FIG. 2 illustrates receptacles 24 and 26 as being holes through which a pin may be passed. The diameter of the pin is preferably slightly larger than the diameter of the hole so that the pin requires some amount of force to be inserted into the hole and does not fall out of the hole without force being applied. When inner member 12 is passed through outer member 16, pins may then be inserted into the receptacles 24 and/or 26 to prevent the handle from extending or retracting past the position of the pin. Optionally, outer member 16 may be equipped with a sleeve or collar 34 such as is illustrated in FIG. 4. Sleeve 34 includes one or more notches or grooves 30 and 32 designed to receive the pins and hold the inner member and outer member in place relative to each other without expansion or retraction during operation of the handle. Other locking mechanisms, such as grooves or notches instead of receptacles, or entirely different devices such as latches, hooks, or clips, may also be used to restrict extension and/or retraction of the handle.

The present inventive handle may be made of any material having sufficient strength to allow for operation of the jack or dolly, such as steel tubing. Steel tubing is preferable because it reduces the weight of the handle while providing strength that can withstand a significant force. However, aluminum tubing or solid aluminum may be used depending on the amount of force that is required. Other materials, such as wood, a composite material such as a carbon fiber composite, resilient plastic, or a reinforced plastic such as a fiberglass reinforced plastic may be used for applications requiring lesser force.

The design of the present inventive handle permits the user to reduce the overall length of the handle when working in a confined space such as underneath a vehicle. It also allows the user to variably increase the length of the handle to reduce the effort required to raise a given load or to increase the handle length to allow the handle to extend to hard-to-reach areas. An increased handle length also allows the handle to act as a tow bar from moving the jack or dolly across the floor. The extended handle, by allowing the user to use less force, permits the user to handle larger loads on the jack.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, all of which may fall within the scope of the invention.

What is claimed is:

1. An extensible handle, comprising:
a first elongated member having two ends, the first end positioned to engage a device to be operated, the first elongated member further comprising an expanded portion of increased width and a narrow portion of reduced width relative to the expanded portion; and
a hollow second elongated member having two ends, the second elongated member positioned to receive the first elongated member, the second elongated member further including a restricting means.

2. The handle of claim 1 wherein the restricting means has a width that is narrower than the width of the expanded portion of the first elongated member.

3. The handle of claim 1 wherein the restricting means restricts the expanded portion of the first elongated member from fully passing through both ends of the second elongated member.

4. The handle of claim 1 wherein at least one of the first elongated member and the second elongated member is comprised of at least one of metal, a composite material, a resilient plastic, and wood.

5. The handle of claim 1 wherein activation of the handle by a user activates a jacking device or dolly.

6. The handle of claim 1 wherein the first elongated member further includes at least one first locking means.

7. The handle of claim 6 wherein at least one of the first locking means comprises a receptacle sized and positioned to securely receive a pin.

8. The handle of claim 7 wherein the second elongated member further includes a second locking means positioned to receive the pin and prevent at least one of extension and retraction of the handle.

9. An apparatus for moving an item comprising:
a base;
a supporting means positioned above the base;
an arm having two ends, the arm positioned so that one end is pivotally related to the supporting member and the other end is pivotally related to the base;
a lifting means; and
a handle comprising:
a first elongated member having two ends, the first end positioned to be received by the apparatus, the second end having an expanded portion of an increased width; and
a second elongated member having two ends, the second elongated member being hollow and positioned to receive the first elongated member, the second elongated member further including a restricting means having a width that is narrower than the width of the expanded portion of the first elongated member.

10. The apparatus of claim 9 wherein the restricting means restricts the expanded portion of the first elongated member from fully passing through the second elongated member.

11. The apparatus of claim 9 wherein at least one of the first and the second elongated member is comprised of at least one of metal, a resilient plastic, a composite material, and wood.

12. The apparatus of claim 9 wherein activation of the handle by a user activates the lifting means, which in turn activates the arm and vertically moves the supporting means.

13. The apparatus of claim 9 wherein the first elongated member further includes at least one first locking means.

14. The apparatus of claim 13 wherein at least one of the first locking means comprises a receptacle sized and positioned to securely receive a pin.

15. The apparatus of claim 14 wherein the second elongated member further includes a second locking means positioned to receive the pin and prevent at least one of extension and retraction of the handle.

16. An extensible handle, comprising:
a first elongated member having two ends, an expanded portion of increased width, and a narrow portion of reduced width relative to the expanded portion; and
a hollow second elongated member having two ends, the second elongated member positioned to telescopically receive the first elongated member and further including a means for restricting the expanded portion of the first elongated member from fully passing through both ends of the second elongated member.

17. The handle of claim 16 wherein the first elongated member further includes a means for restricting movement of the first elongated member on an axis relative to the second elongated member.

18. The handle of claim 16 wherein the handle further includes a means for preventing at least one of extension and retraction of the handle.

19. The handle of claim 16 wherein the first elongated member further includes a means for securing the first elongated member to a device to be operated.

20. The handle of claim 16 wherein at least one of the first elongated member and the second elongated member is comprised of at least one of metal, a resilient plastic, and wood.
